(19) United States
(12) Patent Application Publication
(10) Pub. No.: US 2017/0290296 A1
(43) Pub. Date: Oct. 12, 2017

(54) Pet Toy with Peripheral Groove for Holding Round Objects

(71) Applicant: The KONG Company, LLC, Golden, CO (US)

(72) Inventor: David F. Simon, Lakeland, FL (US)

(73) Assignee: The KONG Company, LLC, Golden, CO (US)

(21) Appl. No.: 15/096,897

(22) Filed: Apr. 12, 2016

(51) Int. Cl. A01K 15/02

(52) U.S. Cl. CPC A01K 15/025; A01K 15/026

(57) ABSTRACT

The pet toy includes two semi-spherical ends or caps interconnected by a curved neck. The curved neck defines a central peripheral channel that enables the curved neck to hold one or more round objects. A noise making device such as a squeaker may be sealed within the pet toy. The exterior surfaces of the semi spherical ends may have a plurality of surface irregularities to include groups of irregular protrusions and grooves disposed between the protrusions. Treats may be selectively secured to the pet toy.

### FIELD OF THE INVENTION

The invention relates to a pet toy having a feature for holding one or more objects, and more particularly, to a pet toy having a continuous peripheral channel that is especially adapted for holding round objects such as a ball.

### BACKGROUND OF THE INVENTION

Due to the increased commercialization of pet products and particularly pet toys, there are now a wide range of commercially available pet toys with distinct functions. Pet toys can be made from many different types of materials along with a nearly limitless number of shapes and colors.

One general category of pet toys is those made of a flexible or elastomeric material, such as rubber. These toys, if made from quality materials, can withstand the biting action of an animal, and can keep an animal occupied for extended periods of time. It is known to place treats in these types of toys to increase the interaction of the animal with the toy. A sound emitting device, often referred to as a “squeaker”, is also known to be placed inside the toy to further stimulate the animal.

Another general category of pet toys are those which may generally be referred to as “plush” toys. These types of toys are made from different types of cloth or fabric, and may also include material woven into strands, such as nylon rope. The plush toy is typically stuffed with a fibrous material, such as polyester stuffing, to provide the toy with an increased thickness or bulk that enables the animal to chew on the toy. Plush toys may also include squeakers to further stimulate the animal.

A few prior art examples exist with reference to pet toys that are capable of holding spherical objects such as a ball. One example is the U.S. Patent No. 6,216,640. This reference discloses a bone-shaped plastic toy that is molded with a tubular central portion and a partial spherical socket on each end of the central portion. The sockets are formed by spring fingers which deflect outwardly to receive and hold a replaceable play ball. Dogs particularly enjoy chewing on balls and can alternately chew on one ball, then the other. A scent can be applied to the toy to enhance its desirability to the dog. If a ball becomes worn, it can be easily replaced. Pets can play with the entire toy, with the balls removed from the toy, or with the toy without the balls, thereby offering a variety of play options for the pet and pet owner.

Other examples of patent references that disclose a pet toy adapted for holding a round object such as a tennis ball is the invention shown and described in U.S. Pat. No. 6,076,829 and US Patent Application Publication No. US 20120048251. This pet toy has a rigid handle, a flexible arm, and a C-shaped head attached to a distal end of the arm. The head is narrow at a central portion, and wider at upper and lower lips. The ball is configured to be releasably retained in the head, and may be, for example, a spherical or a semi-spherical segment.

Considering the common forms of construction for many types of pet toys, there is a need to provide a pet toy with multiple responsive features which may help to entertain an animal longer. There is also a need to provide a pet toy that is robust enough to withstand the prolonged biting action of an animal, but is relatively simple in construction and therefore can be produced at a reasonable cost. There is also a need to provide a pet toy that has multiple responsive features that do not fall within the same general category of pet toys, which may further enhance the entertainment value of the toy for an animal.

The invention described below provides solutions to many limitations in the prior art, yet incorporates a construction that is robust enough to withstand the prolonged biting action of an animal. The invention also provides a pet toy that is relatively simple in structure, but provides multiple distinct features which may enhance an animal's interaction with the pet toy.

### SUMMARY OF THE INVENTION

The pet toy of the invention is includes two semi-spherical ends or caps interconnected by a curved neck. When taken from a cross-sectional view, the curved neck has a semi-circular or semi-oval shape that is capable of retaining a round object such as a ball. Each of the semi-spherical ends maybe of the same general shape, size, and curvature. Alternatively, the semi-spherical ends may have selectively different shapes, sizes, and/or curvatures.

The curved neck defines a central peripheral channel that enables the curved neck to hold one or more round objects. For example, the peripheral channel may be sized so that it can hold at least two tennis balls.

The pet toy may be assembled from three primary components, namely, the two semi-spherical ends and the curved neck. In order to adequately lock and hold the components together, tongue and groove connections can be utilized where the components join one another, along with adhesive or some other bonding agent to secure the connections.

The pet toy may be supported to retain its shape by a plurality of internal structural supports dispersed within the curved neck. Optionally, the internal structural supports may extend into the respective gaps or chambers within the pet toy covered by the semi-spherical ends.

Optionally, a noise making device, such as a squeaker, may be incorporated within the pet toy. A squeaker housing can be molded with one or both of the semi-spherical ends. The squeaker housing extends radially inward with one end secured to the interior surface of the corresponding semi-spherical end and an opposite open end suspended within the gap or chamber of the corresponding semi-spherical end. A traditional squeaker may be inserted within the housing through the open end. According to this squeaker housing configuration, the squeaker is therefore completely sealed within the interior of the pet toy which may prolong the life of the squeaker because an animal cannot easily access the squeaker.

The pet toy can be made of a resilient, flexible, and/or elastomeric material that is capable of being deformed by pressure applied to the pet toy, and then the pet toy returning to its un-deformed shape when pressure is released. Accordingly, the pet toy is responsive to the biting action of an animal such as a dog in which the pet toy collapses or deforms, then rebounds to its original shape.

Dimensionally, the pet toy may be sized so that the peripheral channel is capable of receiving common balls used for play, such as tennis balls. Because the surface defining the peripheral channel can be flexible or elastomeric, balls of varying sizes can be placed and resiliently held within the peripheral channel.

In one preferred embodiment, the pet toy is substantially spherical shaped if the peripheral channel was removed in favor of extending the opposing side edges of the semi-spherical ends. In another preferred embodiment, the pet toy is oval or oblong shaped in which the length of the neck is increased to accommodate larger balls to be placed within the peripheral channel.

The outer surface of the semi-spherical ends may incorporate features to assist in dental cleaning of an animal's teeth and gums, or may have other surface characteristics that enhance the attractiveness of the pet toy for interaction with an animal. For example, the semi-spherical ends may have bumps, ridges, irregular spaced or evenly spaced grooves and ridges, etc.

In one broad aspect of the invention, it can be considered a pet toy with a central peripheral channel. In another broad aspect of the invention, it may be considered a combination of the pet toy with at least one ball held within the central peripheral channel. In yet another broad aspect of the invention, it can be considered a method of entertaining an animal by selectively attaching and removing one or more balls that can be used to play fetch with an animal, or to stimulate the animal in other ways with the pet toy and on or more balls.

According to the method of the invention, the pet toy may serve as a convenient receptacle to retain and store one or more balls. According to another aspect of this method, the pet toy can further stimulate play for an animal by presenting a challenge for the animal to remove the ball(s) from the pet toy.

Paste-like pet treats may be applied to the semi-spherical ends of the pet toy to further enhance interaction with the animal. Treats may also be placed within the peripheral channel and held in place by wedging the treats between the outer surface of the neck defining the channel and the ball(s). Treats secured in the channel will encourage the animal to remove the balls to gain access to the treats. These treats may also be used in selected combinations with one another. Therefore, another aspect of the invention includes a combination of the pet toy, one or more balls, and selected treats. The word “treat” hereinafter is meant to include all animal foodstuffs that can be consumed by an animal. Treats make take various forms such as uniformly sized nuggets, or the treats may be irregularly sized and shaped. Treats may also be in a paste-like form.

Considering these general features of the invention, the invention may be more particularly described as a pet toy comprising: a first enlarged end; a second enlarged end; a curved neck interconnecting the first and second enlarged ends; wherein said curved neck defines an endless peripheral channel that separates said first and second enlarged ends; and wherein said pet toy is substantially symmetrical about an axis extending along said curved neck.

According to another more particular feature of the invention, it may be considered a pet toy comprising: a first semi spherical end; a second semi spherical end; a curved neck interconnecting the first and second semi spherical ends; wherein said curved neck defines an endless peripheral channel that substantially bisects said pet toy and separates said first and second semi spherical ends; and at least one substantially spherical object placed within said endless peripheral channel.

According to yet another particular feature of the invention, it may be considered a method of entertaining an animal comprising: providing a pet toy having a first enlarged end; a second enlarged end; a curved neck interconnecting the first and second enlarged ends; and wherein said curved neck defines an endless peripheral channel that substantially bisects said pet toy and separates said first and second enlarged ends; placing at least one ball within said endless peripheral channel; and giving the pet toy to an animal for the animal to interact with the pet toy. In one embodiment, a pet treat may be retained in the endless peripheral channel by the at least one ball.

Additional features and advantages of the invention will become apparent from review of the following detailed description taken in conjunction with the drawings.

### BRIEF DESCRIPTION OF THE DRAWINGS

FIG. 1 is a front elevation view of the pet toy of the invention;

FIG. 2 is a top plan view of the pet toy of FIG. 1;

FIG. 3 is a perspective view of the pet toy of FIG. 1;

FIG. 4 is a cross-sectional view taken along line 4-4 of FIG. 1;

FIG. 5 is an off-axis cross-sectional view taken along line 5- 5 of FIG. 3;

FIG. 6 is another front elevation view of the pet toy of FIG. 1 with cross-sectional line markings;

FIG. 7 is a cross-sectional view taken along line 7-7 of FIG. 6;

FIG. 8 is another cross-sectional view taken along line 8-8 of FIG. 6;

FIG. 9 is a cross-sectional perspective view of the pet toy of FIG. 1 showing two different sized balls retained within a peripheral channel of the pet toy; and

FIG. 10 is another cross-sectional perspective view of the pet toy of FIG. 1 showing two different sized balls retained within the peripheral channel of the pet toy and treats added to the pet toy.

### DETAILED DESCRIPTION

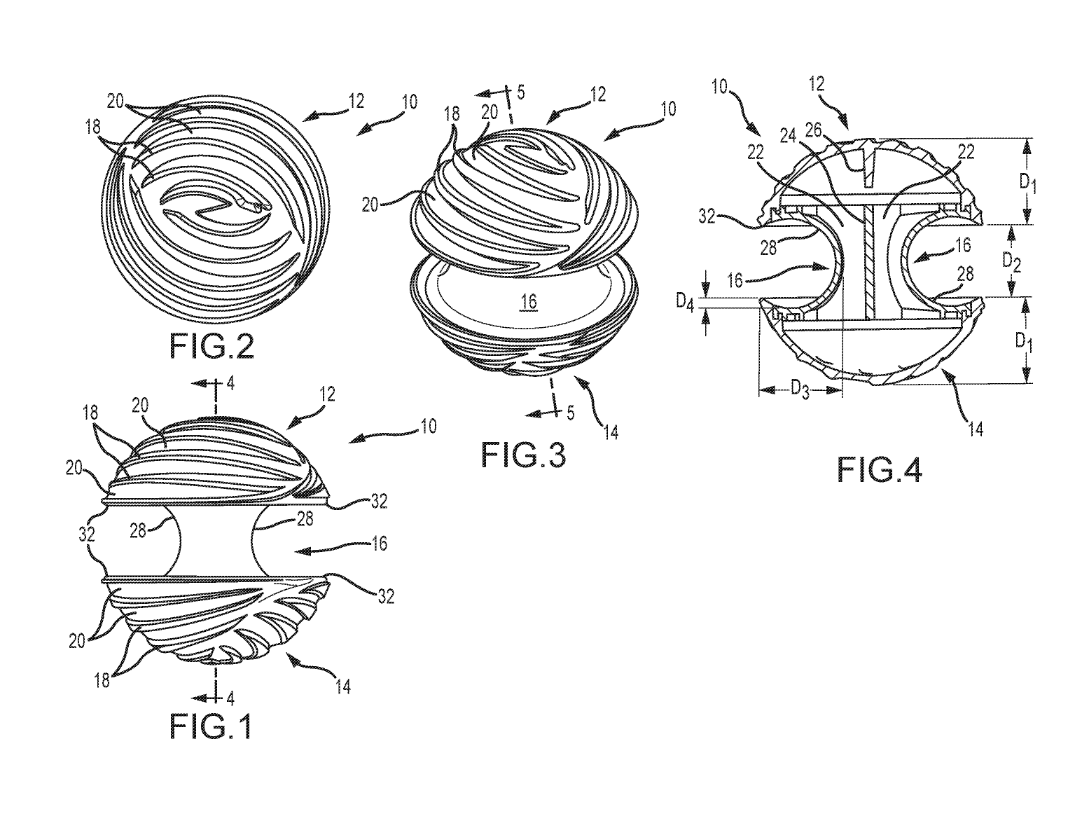

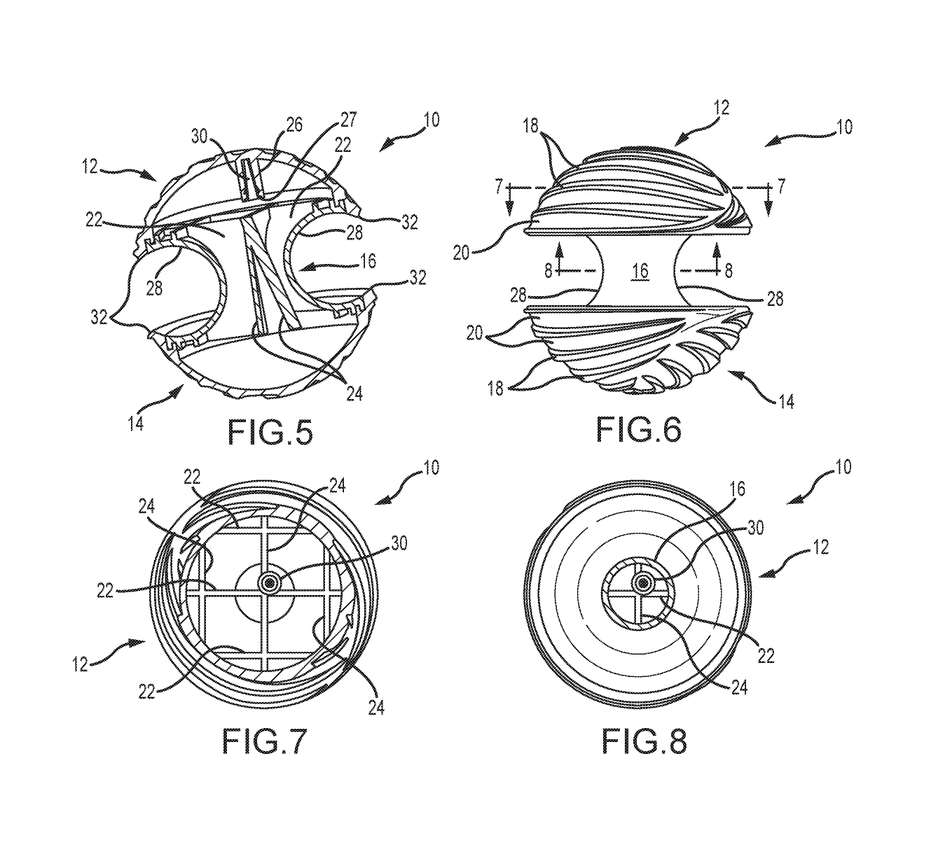

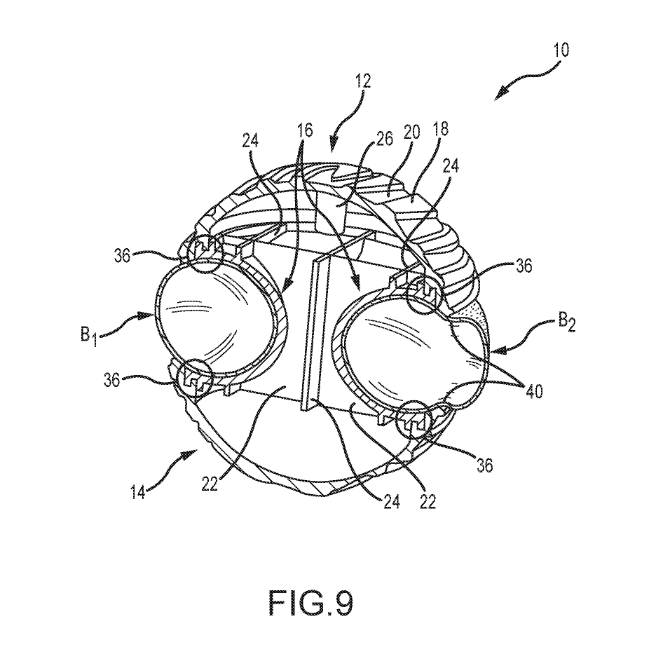

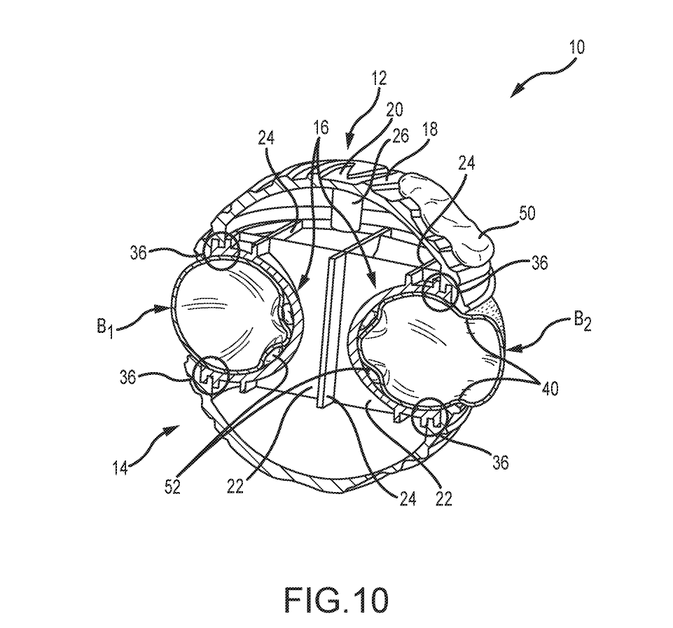

FIGS. 1-8 illustrate a preferred embodiment of the invention as a pet toy. FIG. 9 illustrates another preferred embodiment of the invention comprising a combination of the pet toy with one or more spherical objects, such as tennis balls. FIG. 10 illustrates yet another preferred embodiment comprising a combination of the pet toy, one or more balls, and selected pet treats.

First referring to the embodiment of FIGS. 1-8, the pet toy 10 is illustrated in various views. Three primary parts or components may be used, namely, two opposing enlarged or semi spherical ends 12 and 14 that are interconnected by a curved neck 16. Referring to FIGS. 1 and 4, the semi spherical ends 12 and 14 are shown as having similar sizes and shapes, and the interconnecting neck 16 is sized so the pet toy 10 would have a substantially circular shape in cross-section if the neck 16 was eliminated in favor of extending the curved exterior surfaces of the semi spherical ends 12, 14.

The exposed or exterior surface 28 of the neck 16 defines an endless peripheral channel that is especially adapted for holding round objects such as tennis balls. The cross-sectional shape of the peripheral channel 28 is semicircular with sufficient curvature provided by the corresponding exterior surface of the neck 16 so that the channel may effectively hold one or more balls. The curvature extends so that there is an overhanging lip or ledge 32 when viewing the channel 28 in cross section. Accordingly, in one embodiment, a cross-sectional shape of the peripheral channel 28 is greater than a semicircle. Said another way, in one embodiment, the cross-sectional shape of the peripheral channel 28 has an arc with an angle measure of greater than about 180°. In another embodiment, the angle measure of the arc is about 270°.

FIGS. 4 and 5 also provide dimensional identifiers, namely, D1 for the heights of the semi-spherical ends 12, 14, D2 for height of the peripheral channel 28, and D3 for the depth of the peripheral channel 28. Each of these dimensional parameters can be altered to accommodate the desired size and shape of the toy 10, as well as to accommodate holding balls of the desired size.

The overhanging lip or ledge 32 can be measured by the distance D4 as shown in FIG. 4 which is the distance between the outermost edge of the ledge 32 and the most upper or lower edge of the channel 28 as the toy is oriented in FIG. 4. The overhanging ledge 32 assists in retaining a ball that is seated within the channel 28 by capturing some portion of both opposing sides of a ball.

The exterior surfaces of the semi spherical ends 12 and 14 are shown with a plurality of surface irregularities to include groups of irregular protrusions 18 and grooves 20 disposed between the protrusions. These surface irregularities 18, 20 may serve many purposes such as dental cleaning, oral stimulation, or to hold paste-like treats to further stimulate an animal. It will be appreciated that the surface irregularities may have any shape. Optionally, the plurality of surface irregularities may include dimples and protrusions in addition to, or instead of, the irregular protrusions 18 and grooves 20. Accordingly, in one embodiment, one of the first and second semi spherical ends 12, 14 may include the irregular protrusions 18 and grooves 20 and the other one of the first and second semi spherical ends 12, 14 may include a plurality of dimples and protrusions.

The cross-sectional views of the pet toy 10 shown in FIGS. 4 and 5 illustrate additional interior details, to include various internal structural supports, that can be used to help retain the shape of the curved neck 16 and the shapes of the semi spherical ends 12 and 14. Specifically, these figures show a plurality of first structural supports 22 and a plurality of second structural supports 24 that are disposed at an angle to the first structural supports, such as an orthogonal angle. The offset cross-sectional view of FIG. 5 as compared to the cross-sectional view of FIG. 4 also illustrates that the first or second structural supports 22, 24 may be further disposed at other angles to one another to best support the exterior features of the pet toy 10.

A squeaker housing 26 is also illustrated as being disposed within the chamber or interior open space of one of the semi spherical ends 12. As shown, the housing 26 has an open end 27 which receives a noise making element such as a squeaker 30. The other end of the housing 26 is attached and sealed against the interior surface of the semi-spherical end 12. In this way, the squeaker 30 is protected and an animal cannot make direct contact with the squeaker unless the sidewall of the semi-spherical end 12 is penetrated. It is well known that animals may wish to disable the squeaking sound of the pet toy by chewing on the squeaker. The protected squeaker of the invention helps to prolong the ability of the pet toy to produce sound.

FIGS. 7 and 8 more specifically illustrate the spacing of the internal structural supports 22 and 24 which enhances the structural robustness of the pet toy. These figures also illustrate that the structural supports 22, 24 extend throughout the entire cross-section of the curved neck 16 which therefore enhances the integrity of the pet toy 10 when exposed to the biting action of an animal.

While these figures illustrate that the structural supports 22, 24 are substantially planar in shape, it should be understood that these structural supports 22, 24 do not have to be rigid or stiff, and may therefore be made from the same or similar material as the exterior surfaces of the semi-spherical ends 12 and 14 and the exposed surface 28 of the neck 16. Accordingly, the pet toy 10 maintains a selected flexible, elastomeric characteristic in which the pet toy can be chewed by an animal without injury to the animal's mouth.

FIG. 9 illustrates another embodiment of the pet toy 10 in which two balls B are held within the peripheral channel 28. The ball B1 on the left side of the figure is smaller than the ball B2 on the right side. The left side ball B1 has a size which conveniently fits within the channel 28, and there is little or no compression or deformation of the ball B1. The ball B2 on right side of the figure is larger than the other ball B 1, and undergoes some amount of compression/deformation as it is held within the channel 28. This figure is therefore intended to represent the capability of the pet toy 10 to receive and retain balls B of different sizes in which a ball can be manipulated to fit within the peripheral channel 28 by squeezing a portion of the ball to fit within the peripheral channel. Different sized balls B1, B2 placed in the channel may present varying degrees of difficulty for an animal to remove the balls which therefore adds another feature of the invention regarding a method of entertaining the animal.

Referring to FIGS. 9 and 10, in order to adequately lock and hold the ends 12, 14 and the neck 16 together, tongue and groove connections 36 can be utilized where the components 12, 14, 16 join one another, along with adhesive or some other bonding agent to secure the connections. As shown at 36, the outer peripheral portions of the ends of the neck 16 include a groove and the corresponding peripheral edges of the semi-spherical ends 12 and 14 include tongues or extensions received in the corresponding grooves.

FIG. 10 illustrates yet another embodiment of the pet toy 10 in which paste like treats 50 may be applied to the exterior surfaces of the semi spherical ends 12, 14. The protrusions 18 and grooves 20 help retain the treats 50 on the pet toy 10. FIG. 10 also shows one or more balls B retained within the peripheral channel 28 and selected treats 52 that are secured within the peripheral channel by frictional contact between the exterior surface 28 of the curved neck 16 and the facing exterior surface of the balls B.

From the foregoing embodiments, it can be seen that the pet toy 10 serves numerous potential purposes. One purpose is to act as a retainer or receptacle for one or more balls B. Another purpose is to retain one or more types of pet treats 50, 52. Yet another purpose is for the pet toy 10 to simply serve as a chew toy in which the various curved surfaces 18, 20 of the pet toy 10 may itself stimulate animal play.

While the foregoing invention has been described with respect to one or more preferred embodiments, it shall be understood that the invention can be altered or modified commensurate with the scope of the claims appended hereto.

What is claimed is:

1. A pet toy comprising:
a first enlarged end;
a second enlarged end;
a curved neck interconnecting said first and second enlarged ends;
wherein said curved neck defines an endless peripheral channel that separates said first and second enlarged ends; and
wherein said pet toy is substantially symmetrical about an axis extending along said curved neck.

2. The pet toy, as claimed in claim 1, wherein:
the first and second enlarged ends have semi-spherical shapes.

3. The pet toy, as claimed in claim 1, wherein:
at least one of said first and second enlarged ends includes a plurality of protrusions and grooves formed on an outer surface thereof.

4. The pet toy, as claimed in claim 1, wherein:
said endless peripheral channel substantially bisects said pet toy.

5. The pet toy, as claimed in claim 1, wherein:
said endless peripheral channel has a semi-circular cross-sectional shape.

6. The pet toy, as claimed in claim 1, wherein:
said endless peripheral channel includes an overhanging lip formed along substantially all of a perimeter of said endless peripheral channel.

7. The pet toy, as claimed in claim 1, further comprising:
a housing secured to an interior surface within a chamber of one of the first and second enlarged ends; and
a noise making device secured in said housing.

8. A pet toy comprising:
a first semi spherical end;
a second semi spherical end;
a curved neck interconnecting the first and second semi spherical ends;
wherein said curved neck defines an endless peripheral channel that substantially bisects said pet toy and separates said first and second semi spherical ends; and
at least one substantially spherical object placed within said endless peripheral channel.

9. The pet toy, as claimed in claim 8, wherein:
at least one of said first and second semi spherical ends includes a plurality of protrusions and grooves formed on an outer surface thereof.

10. The pet toy, as claimed in claim 8, wherein:
said peripheral channel has a cross-sectional shape with an arc that is greater than a semi-circle.

11. The pet toy, as claimed in claim 8, wherein:
said endless peripheral channel includes a first overhanging lip formed along substantially all of a perimeter edge of said first semi spherical end and a second overhanging lip formed along substantially all of a perimeter edge of said second semi spherical end.

12. The pet toy, as claimed in claim 8, further comprising:
a noise maker secured within a housing affixed to an interior surface of one of said first semi spherical end and said second semi spherical end.

13. A method of entertaining an animal comprising:
providing a pet toy having:
a first enlarged end;
a second enlarged end;
a curved neck interconnecting the first and second enlarged ends; and
wherein said curved neck defines an endless peripheral channel that substantially bisects said pet toy and separates said first and second enlarged ends;
placing at least one ball within said endless peripheral channel; and
giving the pet toy to an animal for the animal to interact with the pet toy.

14. The method, as claimed in claim 13, further comprising:
securing one or more treats to said pet toy.

15. The method, as claimed in claim 14, wherein:
said one or more pet treats includes a paste like treat applied to an exterior surface of at least one of said first or second enlarged ends.

16. The method, as claimed in claim 15, wherein:
at least one of said first and second enlarged ends includes a plurality of grooves that at least partially receive said paste like treat.

17. The method, as claimed in claim 14, wherein:
said one or more pet treats includes at least one treat placed within said endless peripheral channel and retained therein by contact between an exterior surface of said curved neck and a facing exterior surface of said at least one ball.

18. The method, as claimed in claim 13, wherein:
said endless peripheral channel includes overhanging lips formed along substantially all of perimeter edges of said endless peripheral channel.

19. The method, as claimed in claim 13, wherein:
said endless peripheral channel has a cross-sectional shape with an arc having an angle measure of greater than about 180°.

20. The method, as claimed in claim 13, further comprising:
a chamber formed in the first enlarged end;
a housing secured to an interior surface of said chamber, said housing extending radially inward within said chamber; and
a noise-making squeaker received within said housing.
